(19) United States
(12) Patent Application Publication
(10) Pub. No.: US 2019/0191911 A1
(43) Pub. Date: Jun. 27, 2019

(54) FLEXIBLE AND FORCE-VARIABLE CURTAIN FABRIC RETRACTABLE DEVICE

(71) Applicant: YIJUN WAN, SHENZHEN (CN)

(72) Inventor: YIJUN WAN, SHENZHEN (CN)

(73) Assignee: SHENZHEN KANGER WINDOWS DECORATION CO., LTD., SHENZHEN (CN)

(21) Appl. No.: 15/903,929

(22) Filed: Feb. 23, 2018

(30) Foreign Application Priority Data
Dec. 22, 2017 (CN) 201711404316.7

(51) Int. Cl. A47H 5/032; E06B 9/322; E06B 9/06; E06B 9/60

(52) U.S. Cl. CPC A47H 5/0325; E06B 9/322; E06B 9/90; E06B 9/60; E06B 9/0692

(57) ABSTRACT

The present invention discloses a flexible and force-variable curtain fabric retractable device, including a hollow metal rod for wrapping a curtain fabric and a fixing mounting member mounted on both left and right ends of the hollow metal rod, wherein one end of the hollow metal rod is inlaid and installed with a flexible force-variable elastic structure, and the other end of the hollow metal rod is inlaid and installed with a driven structure, both ends of the hollow metal rod are rotatably connected with a fixing mounting member through a flexible force-variable elastic structure and a driven structure respectively.

### FIELD OF THE INVENTION

The present invention relates to the technical field of curtain retractable device, in particular to a flexible and force-variable curtain fabric retractable device.

### BACKGROUND

Traditional curtains are pulled or retracted manually, which are very inconvenient; in addition, in the prior art, devices used to automatically control the retraction of curtains have low stability and sensitivity, and the retractable structure occupies a large space, so that users cannot achieve free assembly according to different size; moreover, they are difficult to disassemble, with high processing cost.

### SUMMARY

The present invention provides a flexible and force-variable curtain fabric retractable device that addresses the problems of the prior art.

In order to solve the above technical problem, the present invention adopts the following technical solutions:

A flexible and force-variable curtain fabric retractable device, including a hollow metal rod for wrapping a curtain fabric and a fixing mounting member mounted on both left and right ends of the hollow metal rod, wherein one end of the hollow metal rod is inlaid and installed with a flexible force-variable elastic structure, and the other end of the hollow metal rod is inlaid and installed with a driven structure, both ends of the hollow metal rod are rotatably connected with a fixing mounting member through a flexible force-variable elastic structure and a driven structure respectively; the flexible force-variable elastic structure includes a central shaft, a spring mounting base and a volute spiral spring, one end of the central shaft is detachably mounted with a fixing mounting member, a spring mounting base is rotatably inserted on a central shaft, and at least one spring mounting groove are disposed on the spring mounting base, the volute spiral spring is installed in the spring mounting groove, the central end of the volute spiral spring is connected with the central shaft, and the free end of the volute spiral spring is in contact with the inner wall of the hollow metal rod.

Wherein, the driven structure is a plastic plug connector with ribs protruding outwardly, the plastic plug connector is transversely inserted into the hollow metal rod; a rotating cylinder is protrudingly disposed on the side of the plastic plug connector connected with the fixing mounting member, a circular hole is correspondingly disposed at the center of the fixing mounting member, and the rotating cylinder is inserted into the circular hole.

Further, a limiting notch is provided on the plastic plug connector for preventing self-rotation, and a limiting bar matching with the limiting notch is provided inside the hollow metal rod, a limiting slot matching with the limiting bar is provide on the spring mounting base; a curtain fabric insertion slot is formed between the limiting bar and the hollow metal rod, and an elongated opening is provided on the hollow metal rod corresponding to the curtain fabric insertion slot for the curtain fabric to pass through.

Wherein, two spring mounting grooves are juxtaposed on the spring mounting base, two spring mounting grooves are formed by three partition plates; the outer side of the partition plate is provided with a transverse connecting plate, and the three partition plates are connected with the spring mounting base integrally through a transverse connecting plate.

Wherein, a strip hole is radially opened on the central shaft, and the central end of the volute spiral spring is snapped and fixed into the strip hole.

Further, a cross-shaped insertion slot is provided at one end of the central shaft connected to the fixing mounting member, and a “ [symbol] ” shaped plug piece is provided inside the fixing mounting member, and through mutually connecting the cross-shaped insertion slot and the “ [symbol] ” shaped plug piece, the central shaft is connected and assembled with the fixing mounting member.

Wherein, a fixed top plate made of aluminum is provided at the top of two fixing mounting members, the fixed top plate is provided with a rectangular insertion slot, the fixing mounting member is provided with a plug plate corresponding to the rectangular insertion slot, by inserting the plug plate into the rectangular insertion slot, the fixed top plate is assembled with the fixing mounting member at both ends to form a “ [symbol] ” shaped mounting base.

Beneficial Effects:

The invention provides a flexible and force-variable curtain fabric retractable device, including a hollow metal rod for wrapping a curtain fabric and a fixing mounting member mounted on both left and right ends of the hollow metal rod, wherein one end of the hollow metal rod is inlaid and installed with a flexible force-variable elastic structure, and the other end of the hollow metal rod is inlaid and installed with a driven structure, both ends of the hollow metal rod are rotatably connected with a fixing mounting member through a flexible force-variable elastic structure and a driven structure respectively. By simply pushing or pulling the curtain fabric to generate proper power, the volute spiral spring generates deformation to exert a pressing force on the hollow metal rod, and the hollow metal rod can rotate quietly and softly, and stop the intended position accurately, stably and easily without any rebound. The invention can realize the retraction of the curtain fabric by directly pulling the end of the curtain fabric by hand, without requiring the setting of a hand pulling cord or an electric lifting structure; in addition, some parts of the flexible force-variable elastic device and hollow metal rod can be selected or replaced according to the requirements, with high production efficiency, low cost and better cost performance.

### BRIEF DESCRIPTION OF THE DRAWINGS

FIG. 1 is a schematic structural view of the overall structure of a flexible and force-variable curtain fabric retractable device.

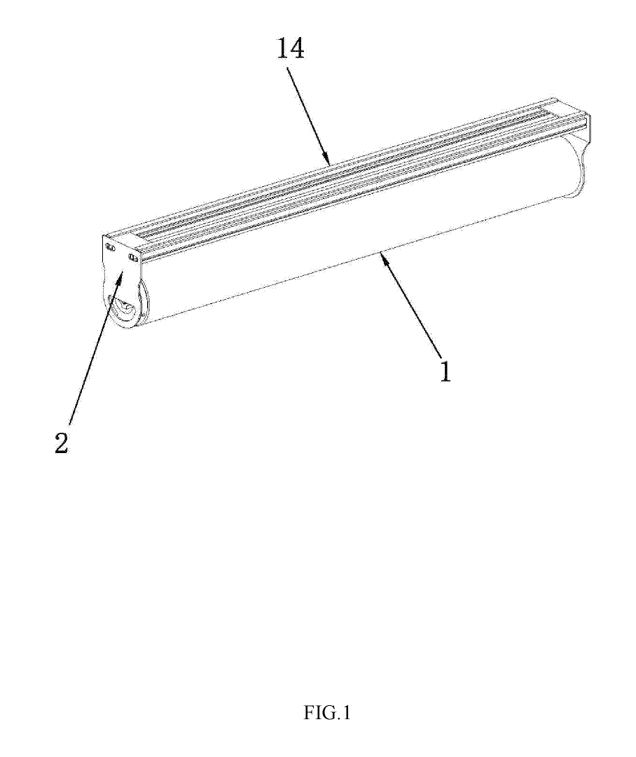

FIG. 2 is an exploded view of a flexible and force-variable curtain fabric retractable device.

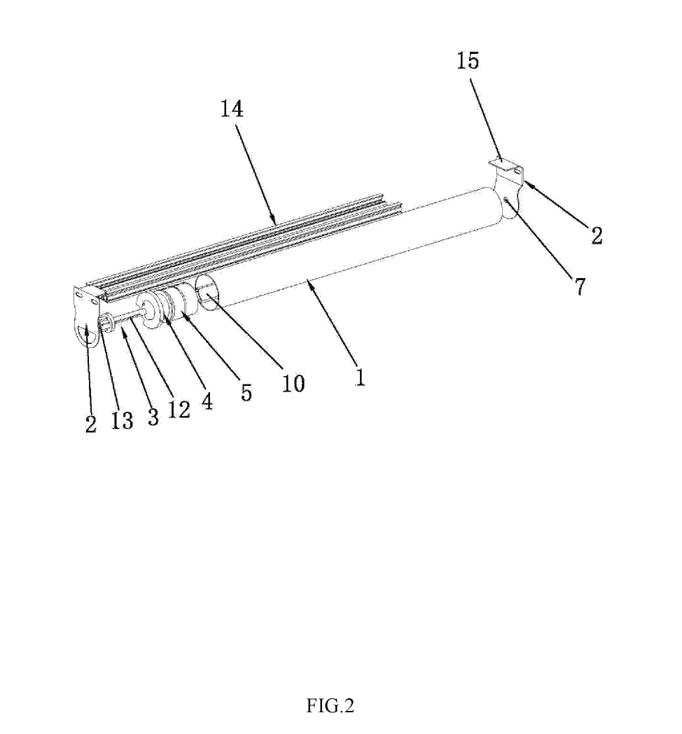

FIG. 3 is a schematic structural view of a combination of a central shaft and a spring mounting base of the present invention.

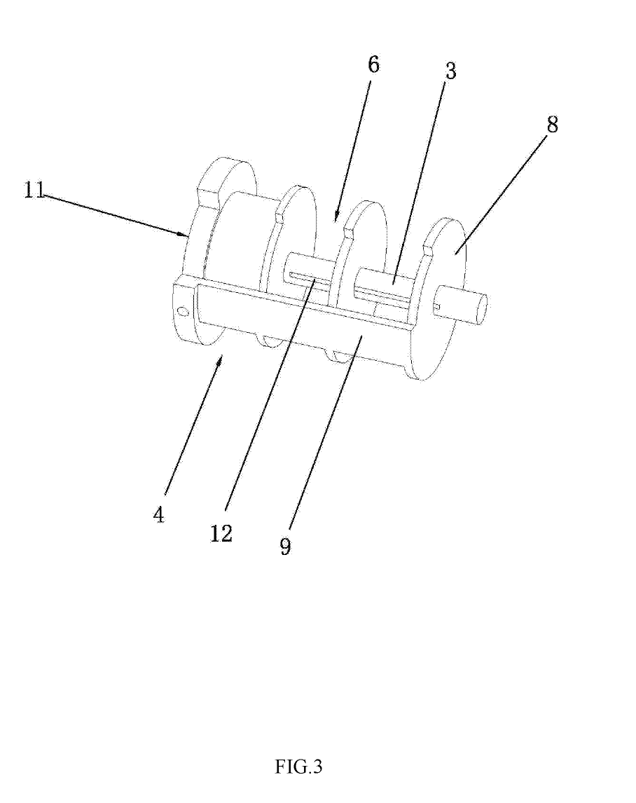

FIG. 4 is a schematic structural view of a plastic plug connector of the present invention.

FIG. 5 is a schematic structural view of a hollow metal rod of the present invention.

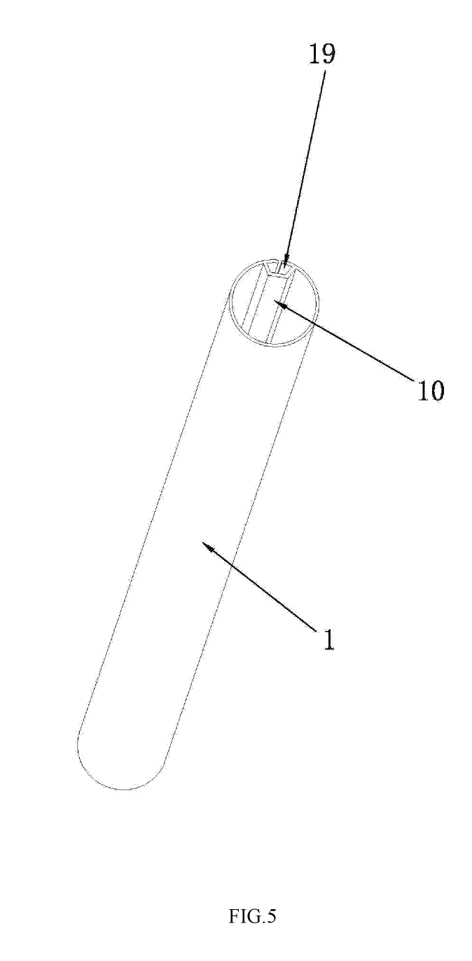

Notes of attached drawings: 1—hollow metal rod; 2—fixing mounting member; 3—central shaft; 4—spring mounting base; 5—volute spiral spring; 6—spring mounting groove; 7—circular hole; 8—partition plate; 9—transverse connecting plate; 10—limiting bar; 11—limiting slot; 12—strip hole; 13—cross-shaped insertion slot; 14—fixed top plate; 15—plug plate; 16—plastic plug connector; 17—rotating cylinder; 18—limiting notch; 19—curtain fabric insertion slot.

### DETAILED DESCRIPTION

For the understanding by those skilled in the art, the present invention is further described in combination with embodiments and accompanying drawings. The contents mentioned in the embodiments are not intended to limit the present invention. The present invention is described in details with reference to the accompanying drawings.

The present invention provides a flexible and force-variable curtain fabric retractable device, including a hollow metal rod 1 for wrapping a curtain fabric and a fixing mounting member 2 mounted on both left and right ends of the hollow metal rod 1, when in use, fixing mounting member 2 can be directly mounted at the top of the window with screws; one end of the hollow metal rod 1 is inlaid and installed with a flexible force-variable elastic structure, and the other end of the hollow metal rod 1 is inlaid and installed with a driven structure, both ends of the hollow metal rod 1 are rotatably connected with a fixing mounting member 2 through a flexible force-variable elastic structure and a driven structure respectively; the flexible force-variable elastic structure includes a central shaft 3, a spring mounting base 4 and a volute spiral spring 5, one end of the central shaft 3 is detachably mounted with a fixing mounting member 2, a spring mounting base 4 is rotatably inserted on a central shaft 3, and at least one spring mounting groove 6 are disposed on the spring mounting base 4, the volute spiral spring 5 is installed in the spring mounting groove 6, the central end of the volute spiral spring 5 is connected with the central shaft 3, and the free end of the volute spiral spring 5 is in contact with the inner wall of the hollow metal rod 1. Before assembly of the flexible force-variable elastic structure, the volute spiral spring 5 is bound with a binding rope tied at the outside; the volute spiral spring 5, central shaft 3 and spring mounting base 4 are combined into a separate mounting accessory. When assembling, after the spring mounting base 4 is aligned with the hollow metal rod 1 and the binding rope is shortened, the entire flexible force-variable elastic structure is inserted into the hollow metal rod 1.

The present invention cleverly utilizes the interaction force to realize the retracting and releasing functions; when the curtain fabric rises, the volute spiral spring 5 is released, and when the curtain fabric drops, the volute spiral spring 5 compresses to produce an interaction force between the volute spiral spring 5 and the hollow metal rod 1. During use, by simply pushing or pulling the curtain fabric to generate proper power, the volute spiral spring 5 generates deformation to exert a pressing force on the hollow metal rod 1, and the hollow metal rod 1 can rotate quietly and softly, and stop the intended position accurately, stably and easily without any rebound. The invention can realize the retraction of the curtain fabric by directly pulling the end of the curtain fabric by hand, without requiring the setting of a hand pulling cord or an electric lifting structure. It can effectively solve the defects of instability and high cost for operation and control for the existing products.

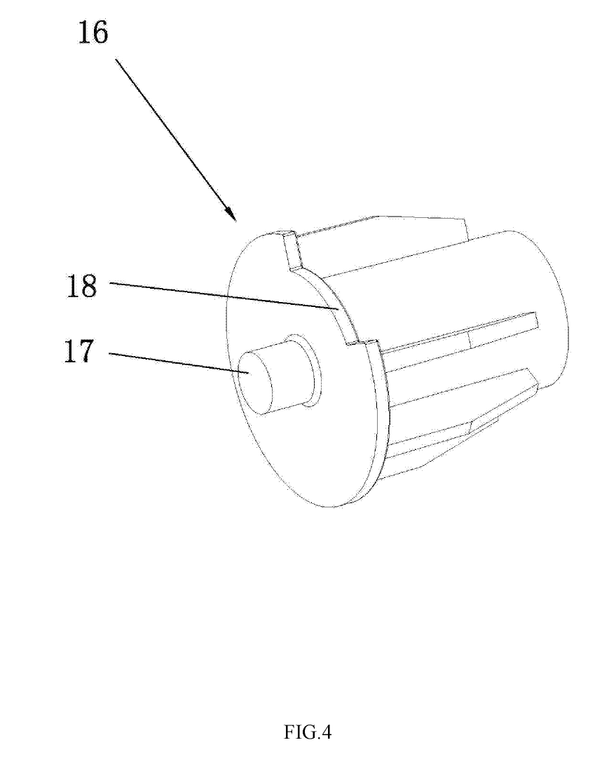

Referring to FIG. 4, in the present invention, the driven structure is a plastic plug connector 16 with ribs protruding outwardly, the plastic plug connector 16 is transversely inserted into the hollow metal rod. When in use, the plastic plug connector 16 is horizontally inserted into the inlet end of the hollow metal rod 1, the plastic plug connector 16 is fixed in contact with the hollow metal rod 1 through a plurality of ribs, and the rib is in interference fit with the inner wall of the hollow metal rod 1, so that the fixing and mounting are simple and convenient. A rotating cylinder 17 is provided convexly on the side where the plastic plug connector 16 is connected with the fixing mounting member 2, a circular hole 7 is correspondingly disposed at the center of the fixing mounting member 2, the rotating cylinder 17 is inserted into the circular hole 7, and the hollow metal rod 1 rotates relative to the fixing mounting member 2 through the rotating cylinder 17.

In addition, as another embodiment, when the length and weight of the curtain fabric used are large, the flexible force-variable elastic structure can be installed on both ends of the hollow metal rod 1, the plastic plug connector 16 can be replaced by the flexible force-variable elastic structure; a reverse force will be generated at both ends of the hollow metal rod 1, broadening the applications of the curtain fabric retractable device.

Further, a limiting notch 18 is provided on the plastic plug connector 16 for preventing self-rotation, and a limiting bar 10 matching with the limiting notch 18 is provided inside the hollow metal rod 1, a limiting slot 11 matching with the limiting bar 10 is provide on the spring mounting base 4. When the spring mounting base 4 is mounted, the combined mounting is achieved quickly by the guidance of the limiting bar 10 and limiting slot 11. In addition, the limiting bar 10 can match with the limiting slot 11, to prevent self-rotation of the spring mounting base 4. A curtain fabric insertion slot 19 is formed between the limiting bar 10 and the hollow metal rod 1, and an elongated opening is provided on the hollow metal rod 1 corresponding to the curtain fabric insertion slot 19 for the curtain fabric to pass through. When the curtain fabric is installed, the installation side of the curtain fabric is inserted from the side of the curtain fabric insertion slot 19, so that the user does not need to remove the plastic plug connector 16 to replace the curtain fabric.

In the present invention, two spring mounting grooves 6 are juxtaposed on the spring mounting base 4, two spring mounting grooves 6 are formed by three partition plates 8; the outer side of the partition plate 8 is provided with a transverse connecting plate 9, and the three partition plates 8 are connected with the spring mounting base 4 integrally through a transverse connecting plate 9. The volute spiral spring 5 is separated by the partition plate 8, to avoid the interference each other. The retraction capability of flexible force-variable elastic structure is mainly determined by the recovery capability of volute spiral spring 5. The larger the recovery force generated by the deformation of volute spiral spring 5, the longer or wider the curtain fabric that is installed on hollow metal rod 1. Therefore, two spring mounting base 4 are juxtaposed on the spring mounting base 4, to expand its application scope.

Further, the end of the spring mounting base 4 may also be provided with a snap hole for snap-fitting, one additional partition plate 8 is inserted in the snap hole, and one spring mounting groove 6 is added, so that one more volute spiral spring 5 can be installed, to further enhance the elastic force of flexible force-variable elastic structure.

In the present invention, a strip hole 12 is radially opened on the central shaft 3, and the central end of the volute spiral spring 5 is snapped and fixed into the strip hole 12. The strip hole 12 can facilitate the winding of the volute spiral spring 5, improving the production efficiency.

Further, a cross-shaped insertion slot 13 is provided at one end of the central shaft 3 connected to the fixing mounting member 2, and a “ [symbol] ” shaped plug piece (not shown in the figure) is provided inside the fixing mounting member 2, and through mutually connecting the cross-shaped insertion slot 13 and the “ [symbol] ” shaped plug piece, the central shaft 3 is connected and assembled with the fixing mounting member 2, so that the central shaft 3 cannot rotate; when deformation of the volute spiral spring 5 occurs, its center does not self-rotate, to effectively ensure the stable force of the volute spiral spring 5.

In the present invention, a fixed top plate 14 made of aluminum is provided at the top of two fixing mounting members 2, the fixed top plate 14 is provided with a rectangular insertion slot, the fixing mounting member 2 is provided with a plug plate 15 corresponding to the rectangular insertion slot, by inserting the plug plate 15 into the rectangular insertion slot, the fixed top plate 14 is assembled with the fixing mounting member 2 at both ends to form a “ [symbol] ” shaped mounting base, with better supporting force. The hollow metal rod 1 and the fixed top plate 14 are made of aluminum; users can perform DIY cutting and installation according to the width of the curtain.

The foregoing descriptions are merely exemplary embodiments of the present invention, but not intended to limit the present invention in any form. Although the present invention is disclosed by preferred embodiments, it is not intended to limit the present invention. Technicians skilled in the art can make some changes or modifications made equivalent to the technical contents disclosed herein without departing from the technical solution of the present invention. All technical contents without departing from the technical solution of the present invention, and any simple modifications, equivalent changes and modifications made to the above embodiments will fall within the scope of the protection of the present invention.

What is claimed is:

1. A flexible and force-variable curtain fabric retractable device, comprising a hollow metal rod for wrapping a curtain fabric and a fixing mounting member mounted on both left and right ends of the hollow metal rod, wherein one end of the hollow metal rod is inlaid and installed with a flexible force-variable elastic structure, and the other end of the hollow metal rod is inlaid and installed with a driven structure, both ends of the hollow metal rod are rotatably connected with a fixing mounting member through a flexible force-variable elastic structure and a driven structure respectively; the flexible force-variable elastic structure comprises a central shaft, a spring mounting base and a volute spiral spring, one end of the central shaft is detachably mounted with a fixing mounting member, a spring mounting base is rotatably inserted on a central shaft, and at least one spring mounting groove are disposed on the spring mounting base, the volute spiral spring is installed in the spring mounting groove, the central end of the volute spiral spring is connected with the central shaft, and the free end of the volute spiral spring is in contact with the inner wall of the hollow metal rod.

2. The flexible and force-variable curtain fabric retractable device according to claim 1, wherein the driven structure is a plastic plug connector with ribs protruding outwardly, the plastic plug connector is transversely inserted into the hollow metal rod; a rotating cylinder is protrudingly disposed on the side of the plastic plug connector connected with the fixing mounting member, a circular hole is correspondingly disposed at the center of the fixing mounting member, and the rotating cylinder is inserted into the circular hole.

3. The flexible and force-variable curtain fabric retractable device according to claim 2, wherein a limiting notch is provided on the plastic plug connector for preventing self-rotation, and a limiting bar matching with the limiting notch is provided inside the hollow metal rod, a limiting slot matching with the limiting bar is provide on the spring mounting base; a curtain fabric insertion slot is formed between the limiting bar and the hollow metal rod, and an elongated opening is provided on the hollow metal rod corresponding to the curtain fabric insertion slot for the curtain fabric to pass through.

4. The flexible and force-variable curtain fabric retractable device according to claim 1, wherein two spring mounting grooves are juxtaposed on the spring mounting base, two spring mounting grooves are formed by three partition plates; the outer side of the partition plate is provided with a transverse connecting plate, and the three partition plates are connected with the spring mounting base integrally through a transverse connecting plate.

5. The flexible and force-variable curtain fabric retractable device according to claim 1, wherein a strip hole is radially opened on the central shaft, and the central end of the volute spiral spring is snapped and fixed into the strip hole.

6. The flexible and force-variable curtain fabric retractable device according to claim 5, wherein a cross-shaped insertion slot is provided at one end of the central shaft connected to the fixing mounting member, and a “ [symbol] ” shaped plug piece is provided inside the fixing mounting member, and through mutually connecting the cross-shaped insertion slot and the “ [symbol] ” shaped plug piece, the central shaft is connected and assembled with the fixing mounting member.

7. The flexible and force-variable curtain fabric retractable device according to claim 1, wherein a fixed top plate made of aluminum is provided at the top of two fixing mounting members, the fixed top plate is provided with a rectangular insertion slot, the fixing mounting member is provided with a plug plate corresponding to the rectangular insertion slot, by inserting the plug plate into the rectangular insertion slot, the fixed top plate is assembled with the fixing mounting member at both ends to form a “ [symbol] ” shaped mounting base.
